(19) United States
(12) Patent Application Publication
(10) Pub. No.: US 2026/0370867 A1
(43) Pub. Date: Nov. 19, 2026

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Koichi NIHEI, Tokyo (JP); Takanori IWAI, Tokyo (JP); Florian BEYE, Tokyo (JP); Hayato ITSUMI, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 19/103,256

(22) PCT Filed: Aug. 31, 2022
(86) PCT No.: PCT/JP2022/032760

§ 371 Date: Feb. 12, 2025

(51) Int. Cl. H04N 19/52; G06T 7/246; H04N 19/139; H04N 19/20

(52) U.S. Cl. CPC H04N 19/52; G06T 7/246; H04N 19/139; H04N 19/20; G06T 2207/10016

(57) ABSTRACT

A video processing system (10) is a system that processes a video captured by a sensor. The video processing system (10) includes: a motion recognition unit (11) that recognizes a motion of an object included in a first video captured by the sensor; and a control unit (12) that controls a change in a display content for each frame of a second video captured by the sensor for each region in the second video according to a recognition result of the motion of the object included in the first video recognized by the motion recognition unit (11).

### TECHNICAL FIELD

The present disclosure relates to a video processing system, a video processing apparatus, and a video processing method.

### BACKGROUND ART

A technology for changing a frame rate of a video has been developed. Patent Literatures 1 and 2 are known as related technologies. Patent Literature 1 describes a technology of detecting an action of a person in a video, performing weighting according to a type and order of the action, and determining a capturing view angle of a camera, and also describes that a frame rate may be increased in an important scene according to a weight value. In addition, Patent Literature 2 describes that an analysis section is determined according to a calculation result of a motion amount between frames in a predetermined evaluation portion, and a frame rate of a section other than the determined analysis section is lowered.

### CITATION LIST

### Patent Literature

Patent Literature 1: Japanese Unexamined Patent Application Publication No. 2020-072457

Patent Literature 2: Japanese Unexamined Patent Application Publication No. 2021-118501

### SUMMARY OF INVENTION

### Technical Problem

In the related technologies such as Patent Literature 1 and Patent Literature 2, a data amount of the video can be reduced to some extent by controlling the frame rate according to a scene of the video, the motion amount of the evaluation portion, and the like. However, in the related technologies, it is assumed that the frame rate of all the frames is controlled by changing the number of frames per unit time, and thus, the data amount cannot be appropriately reduced in some cases. For example, in a case of distributing the video in which the frame rate is controlled via a network, there is a possibility that a quality of the distributed video deteriorates depending on an available resource amount of the network. A communication amount increases in a case where there are many important scenes in Patent Literature 1 and in a case where the analysis section is long in Patent Literature 2, which may lead to delay and disturbance of the video.

In view of such a problem, an object of the present disclosure is to provide a video processing system, a video processing apparatus, and a video processing method capable of appropriately controlling a data amount of a video.

### Solution to Problem

A video processing system according to the present disclosure includes: motion recognition means for recognizing a motion of an object included in a first video captured by a sensor; and control means for controlling a change in a display content for each frame of a second video captured by the sensor for each region in the second video according to a recognition result of the motion.

A video processing apparatus according to the present disclosure includes: motion recognition means for recognizing a motion of an object included in a first video captured by a sensor; and control means for controlling a change in a display content for each frame of a second video captured by the sensor for each region in the second video according to a recognition result of the motion.

A video processing method according to the present disclosure includes: recognizing a motion of an object included in a first video captured by a sensor; and controlling a change in a display content for each frame of a second video captured by the sensor for each region in the second video according to a recognition result of the motion.

### Advantageous Effects of Invention

According to the present disclosure, it is possible to provide a video processing system, a video processing apparatus, and a video processing method capable of appropriately controlling a data amount of a video.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a configuration diagram illustrating an outline of the video processing apparatus according to the example embodiment.

FIG. 4 is a flowchart illustrating an outline of a video processing method according to the example embodiment.

FIG. 5 is a diagram for describing the video processing method according to the example embodiment.

FIG. 6 is a configuration diagram illustrating a basic configuration of a remote monitoring system.

FIG. 7 is a configuration diagram illustrating a configuration example of a terminal according to a first example embodiment.

FIG. 8 is a configuration diagram illustrating a configuration example of a center server according to the first example embodiment.

FIG. 9 is a diagram illustrating an example of a motion-frame rate association table according to the first example embodiment.

FIG. 10 is a flowchart illustrating an operation example of the remote monitoring system according to the first example embodiment.

FIG. 11 is a diagram for describing video acquisition processing according to the first example embodiment.

FIG. 12 is a diagram for describing motion recognition processing according to the first example embodiment.

FIG. 13 is a diagram for describing frame rate determination processing according to the first example embodiment.

FIG. 14 is a diagram for describing the frame rate determination processing according to the first example embodiment.

FIG. 15 is a diagram for describing frame rate control processing according to the first example embodiment.

FIG. 16 is a diagram for describing the frame rate control processing according to the first example embodiment.

FIG. 17 is a configuration diagram illustrating a configuration example of a terminal according to a first modified example of the first example embodiment.

FIG. 18 is a configuration diagram illustrating a configuration example of a center server according to the first modified example of the first example embodiment.

FIG. 19 is a configuration diagram illustrating a configuration example of a terminal according to a second modified example of the first example embodiment.

FIG. 20 is a configuration diagram illustrating a configuration example of a center server according to the second modified example of the first example embodiment.

FIG. 21 is a configuration diagram illustrating a configuration example of a terminal according to a third modified example of the first example embodiment.

FIG. 22 is a configuration diagram illustrating a configuration example of a terminal according to a fourth modified example of the first example embodiment.

FIG. 23 is a configuration diagram illustrating a configuration example of a terminal according to a second example embodiment.

FIG. 24 is a configuration diagram illustrating a configuration example of an encoder according to the second example embodiment.

FIG. 25 is a configuration diagram illustrating a configuration example of a terminal according to a first modified example of the second example embodiment.

FIG. 26 is a configuration diagram illustrating a configuration example of a frame rate determination unit according to a second modified example of the second example embodiment.

FIG. 27 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

First, an outline of an example embodiment will be described. FIG. 1 illustrates a schematic configuration of a video processing system 10 according to the example embodiment. The video processing system 10 is applicable to, for example, a remote monitoring system that distributes a video via a network and monitors the distributed video.

As illustrated in FIG. 1, the video processing system 10 includes a motion recognition unit 11 and a control unit 12. The motion recognition unit 11 recognizes a motion of an object included in a first video captured by a sensor. The sensor is image capturing means such as a camera. The motion of the object includes an action such as work performed by a person, a motion of an animal as well as a motion of a person, and a motion of another object such as a machine or a tool.

The control unit 12 controls a change in a display content for each frame of a second video captured by the sensor for each region in the second video according to a recognition result of the motion of the object. For example, the recognition result of the object includes a type of the motion of the object. Furthermore, the recognition result of the object may include position information of the object. For example, the control unit 12 may control a change in a display content of a region including a region corresponding to the position information of the object or a region other than the region including the region corresponding to the position information of the object. The display content of the region or a content of the region is a content displayed by pixels in the region, and is a partial image of a partial range in the frame. For example, the control unit 12 may control the change in the display content of the frame of the second video by copying a content of a predetermined region of a frame before a first frame to a predetermined region of the first frame included in the second video. Controlling the change in the display content for each frame of the video is, for example, controlling a substantial frame rate. The substantial frame rate is the number of frames in which the display content of the region changes from the immediately previous frame per unit time in a case where the video is displayed. Note that the number of frames per unit time is also referred to as an encoding frame rate. If not specified otherwise, the frame rate may indicate either or both of the substantial frame rate and the encoding frame rate. As described above, the substantial frame rate of the predetermined region can be lowered by copying the content of the predetermined region of the previous frame. For example, in a case where the recognition result of the motion of the object is a motion that can be recognized using the video with a low frame rate, it is possible to control the change in the display content of the region indicated by the recognition result and to lower the substantial frame rate.

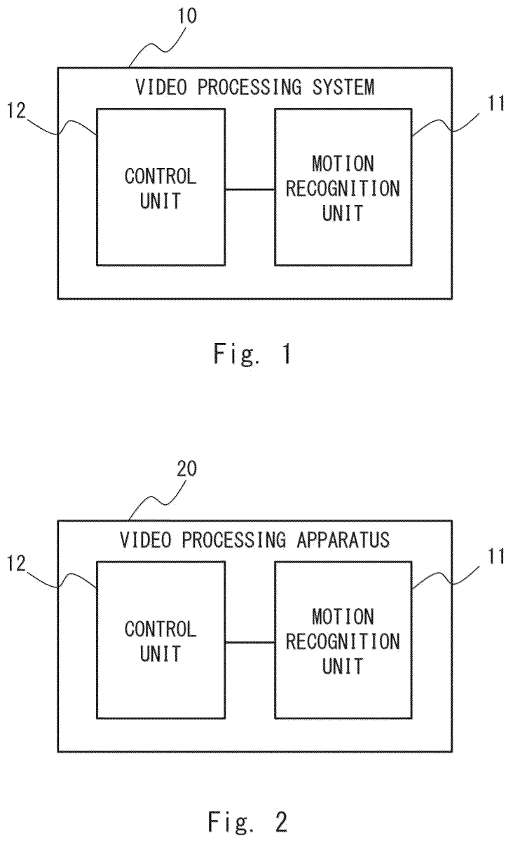

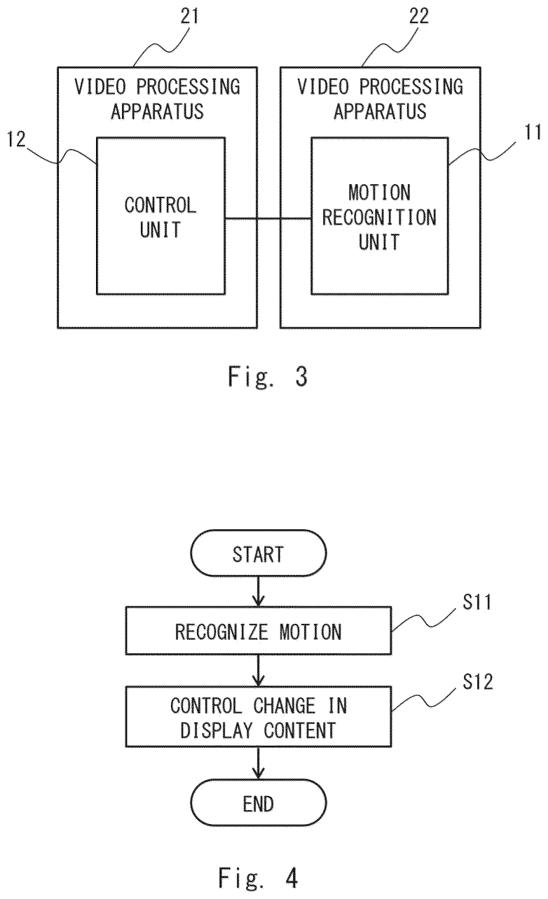

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the motion recognition unit 11 and the control unit 12 illustrated in FIG. 1. In addition, a part of or the entirety of the video processing system 10 may be disposed on an edge or a cloud. For example, an apparatus placed in a site or near the site is referred to as the edge, and an apparatus such as a server placed at a remote location connected to the network is referred to as the cloud. FIG. 3 illustrates a configuration in which functions of the video processing system 10 are arranged in a plurality of video processing apparatuses. In the example of FIG. 3, a video processing apparatus 21 includes the control unit 12, and a video processing apparatus 22 includes the motion recognition unit 11. For example, the video processing apparatus 21 may be a terminal of the edge, and the video processing apparatus 22 may be a server of the cloud.

FIG. 4 illustrates a video processing method according to the example embodiment. For example, the video processing method according to the example embodiment is performed by the video processing system 10 of FIG. 1 or by the video processing apparatuses 20 to 22 of FIG. 2 or 3. As illustrated in FIG. 4, the motion recognition unit 11 recognizes the motion of the object included in the first video captured by the sensor (S11). Next, the control unit 12 controls the change in the display content for each frame of the second video captured by the sensor for each region in the second video according to the recognition result of the motion of the object (S12). The control unit 12 controls the substantial frame rate of the region indicated by the recognition result by controlling the change in the display content of the region indicated by the recognition result.

Here, a system in which a video is distributed from the terminal of the edge to the server of the cloud via the network and the server analyzes the video will be considered. In such a system, there is a problem that it is difficult to appropriately control the frame rate in a case where distributing the video from the terminal to the server. Specifically, if the video with the lowered frame rate is distributed from the terminal, a communication amount of the distributed video is reduced, but recognition accuracy in the server deteriorates. Further, if the video with the increased frame rate is distributed from the terminal, the recognition accuracy in the server is improved, but the communication amount of the distributed video increases. Therefore, in the example embodiment, it is possible to reduce the communication amount while maintaining the recognition accuracy by appropriately controlling the frame rate of the distributed video.

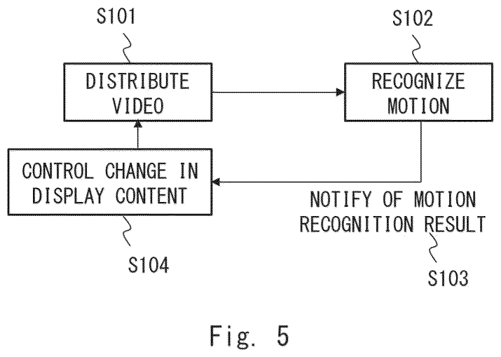

FIG. 5 illustrates an operation example in a case where the video is distributed from the terminal of the edge to the server of the cloud in the video processing method according to the example embodiment. For example, the video processing system that performs the video processing method of FIG. 5 may further include a video distribution unit in addition to the configuration of FIG. 1 in order to distribute the video and recognize the motion from the distributed video. For example, in a case where processing performance of the terminal which is an edge device is low, it is difficult for the terminal to recognize a work content, and thus, it is necessary to distribute the video to the server of the cloud and process the video. Note that the terminal may perform lightweight recognition processing such as object detection. For example, the terminal may include the video distribution unit and the control unit, and the server may include the motion recognition unit.

As illustrated in FIG. 5, in the video processing method according to the example embodiment, the video distribution unit distributes the video input from the sensor such as a camera to the server via the network (S101). Next, the motion recognition unit acquires the distributed video, and recognizes the motion of the object from the acquired video (S102). Next, the motion recognition unit notifies the terminal of the recognition result of the motion of the object (S103). Next, the control unit controls the change in the display content for each frame of the distributed video based on the sent motion recognition result (S104). That is, the motion recognition result of the distributed video is fed back, and the substantial frame rate of the video to be distributed next is controlled according to the fed back motion recognition result. Further, the video distribution unit distributes the video in which the substantial frame rate is controlled, and S101 to S104 are repeatedly executed.

As described above, in the example embodiment, the motion of the object included in the video is recognized, and the change in the display content for each frame of each region in the video is controlled according to the recognition result of the motion of the object. Specifically, the substantial frame rate of each region is controlled. As a result, the frame rate can be controlled to a frame rate corresponding to a motion to be recognized, and since the substantial frame rate can be controlled for each region unlike a case where the frame rate of all the frames is controlled, the frame rate can be made higher than those of other regions only for a region requiring a high frame rate, so that a data amount of the video can be appropriately controlled. Therefore, the communication amount can be reduced while maintaining the recognition accuracy. For example, the data amount can be reduced in a case where the video is encoded and transmitted by making the substantial frame rate of the region corresponding to the motion recognition result in the video lower than the encoding frame rate. The reason why a data length can be reduced is that the data amount increases in proportion to a difference in content between the frames at the time of encoding. Furthermore, by reducing the substantial frame rate of each region in the video according to the motion recognition result, the substantial frame rate can be controlled according to the frame rate used for the recognition of the motion, so that the recognition accuracy of the motion can be maintained. In addition, the substantial frame rate of the region requiring a high frame rate according to the motion recognition result is not changed, and the substantial frame rates of other regions are lowered, so that it is possible to improve the recognition accuracy of the motion of the object of a specific region and to reduce the data amount as compared with a case of simply transmitting the video with a high frame rate of the entire video.

### Basic Configuration of Remote Monitoring System

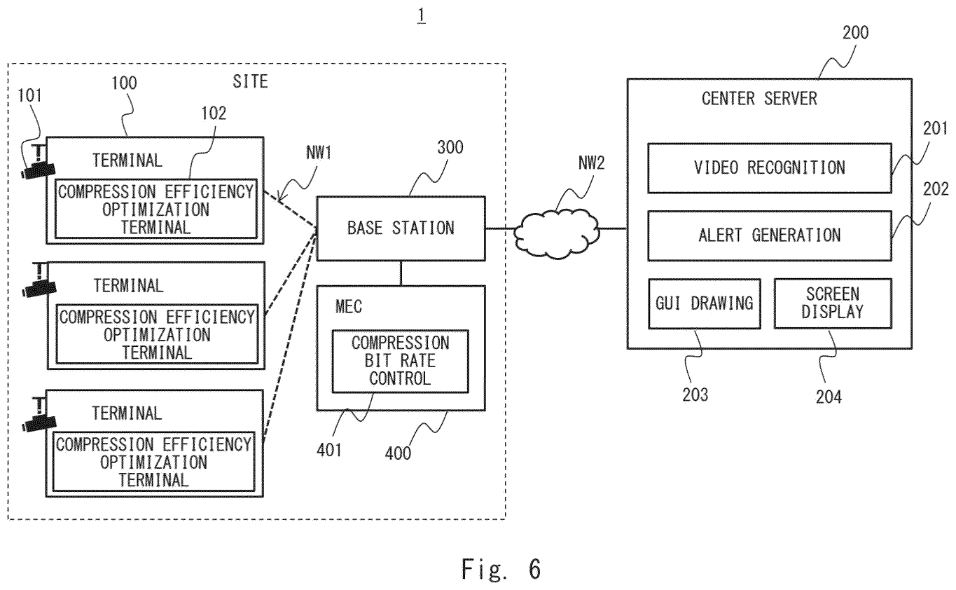

Next, the remote monitoring system that is an example of a system to which the example embodiment is applied will be described. FIG. 6 illustrates a basic configuration of a remote monitoring system 1. The remote monitoring system 1 is a system that monitors a captured area by a video captured by a camera. The present example embodiment will be described below as a system that remotely monitors work of a worker in a site. For example, the site may be an area where people and machines operate, such as a work site or a factory, for example, a construction site, a square where people gather, a station, or a school. In the present example embodiment, the work will be described below as construction work, civil engineering work, or the like, but the work is not limited thereto. Note that the video includes a plurality of time-series images (also referred to as frames), and thus the terms video and image can be used interchangeably. That is, the remote monitoring system can be said to be a video processing system that processes a video or an image processing system that processes an image.

As illustrated in FIG. 6, the remote monitoring system 1 includes a plurality of terminals 100, a center server 200, a base station 300, and a multi-access edge computing (MEC) 400. The terminal 100, the base station 300, and the MEC 400 are disposed on a site side, and the center server 200 is disposed on a center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network. The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video distribution apparatus that distributes a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency. The compression efficiency optimization function 102 performs region of interest (ROI) control for controlling an image quality of an ROI in the video. The ROI is a predetermined region in the video. The ROI may be a region including a recognition target of a video recognition function 201 of the center server 200, or may be a region to be gazed by a user. The compression efficiency optimization function 102 reduces the bit rate by lowering an image quality of a region around the ROI including a person or an object while maintaining the image quality of the ROI. Furthermore, the terminal 100 may include a frame rate control unit that controls the substantial frame rate of each region in the input video.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, and may be another relay apparatus.

The multi-access edge computing (MEC) 400 is an edge processing apparatus disposed on the edge side of the system. The MEC 400 is an edge server that controls the terminal 100, and has a compression bit rate control function 401 for controlling the bit rate of the terminal. The compression bit rate control function 401 controls the bit rate of the terminal 100 by adaptive video distribution control or quality of experience (QoE) control. The adaptive video distribution control controls a bit rate or the like of a video to be distributed according to the situation of the network. In addition, in the QoE control, the bit rate or the like of the video to be distributed is controlled according to a perceived quality of the user and the recognition accuracy. For example, the compression bit rate control function 401 assigns the bit rate to the video distributed by the camera 101 of each terminal 100 such that the recognition accuracy is improved according to a communication environment of the networks NW1 and NW2. Furthermore, the communication environment of the networks NW1 and NW2 may be predicted, and the bit rate may be assigned. The compression bit rate control function 401 may predict the recognition accuracy obtained in a case where the distributed video is input into a recognition model by reducing the bit rate of the video. Note that the control is not limited to the control of the bit rate, and a frame rate of the distributed video may be controlled according to the situation of the network.

The center server 200 is a server installed on the center side of the system. The center server 200 may be one or a plurality of physical servers, a cloud server constructed on the cloud, or other virtualization servers. The center server 200 is a monitoring apparatus that monitors work in a site by analyzing and recognizing a camera video of the site. The center server 200 is also a video reception apparatus that receives a video transmitted from the terminal 100.

The center server 200 has a video recognition function 201, an alert generation function 202, a graphical user interface (GUI) drawing function 203, and a screen display function 204. The video recognition function 201 inputs the video transmitted from the terminal 100 to a video recognition artificial intelligence (AI) engine, thereby recognizing the work performed by the worker, that is, a type of the motion of the object. The video recognition function 201 corresponds to the motion recognition unit that recognizes the motion of the object included in the video.

The alert generation function 202 generates an alert according to recognized work. The GUI drawing function 203 displays a graphical user interface (GUI) on a screen of a display apparatus. The screen display function 204 displays a video, a recognition result, an alert, and the like of the terminal 100 on the GUI. Note that any of the functions may be omitted or any of the functions may be included as necessary. For example, the center server 200 does not have to include the alert generation function 202, the GUI drawing function 203, and the screen display function 204.

### First Example Embodiment

Next, a first example embodiment will be described. In the present example embodiment, an example of controlling the substantial frame rate of the video according to the motion recognition result of the video will be described.

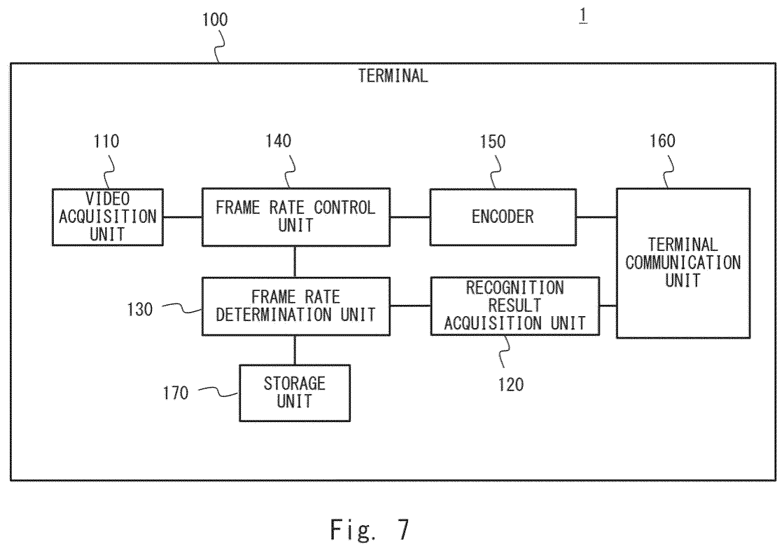

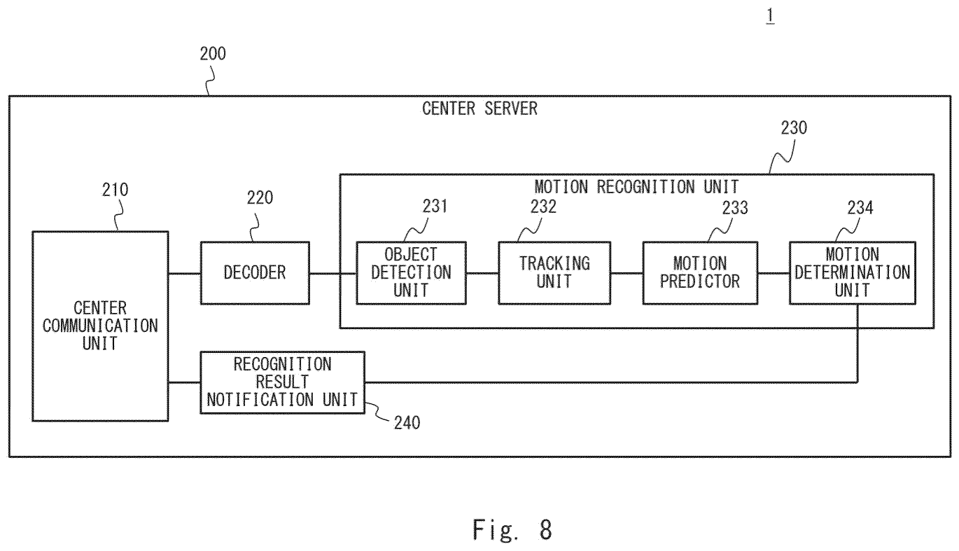

First, a configuration of the remote monitoring system according to the present example embodiment will be described. A basic configuration of the remote monitoring system 1 according to the present example embodiment is as illustrated in FIG. 6. Here, a configuration example of the terminal 100 and the center server 200 will be described. FIG. 7 illustrates a configuration example of the terminal 100 according to the present example embodiment, and FIG. 8 illustrates a configuration example of the center server 200 according to the present example embodiment.

Note that the configuration of each apparatus is an example, and another configuration may be used as long as an operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 having the compression bit rate control function may be disposed in the center server 200, the terminal 100, or the like.

As illustrated in FIG. 7, the terminal 100 includes a video acquisition unit 110, a recognition result acquisition unit 120, a frame rate determination unit 130, a frame rate control unit 140, an encoder 150, a terminal communication unit 160, and a storage unit 170.

The video acquisition unit 110 acquires a video captured by the camera 101. The video captured by the camera is hereinafter also referred to as an input video. For example, the input video includes a person who is a worker who performs work in a site, a work object used by the person, and the like. The video acquisition unit 110 is also an image acquisition unit that acquires a plurality of time-series images, that is, frames.

The recognition result acquisition unit 120 acquires the motion recognition result received by the terminal communication unit 160 from the center server 200. Note that the recognition result acquisition unit 120 may be incorporated in the terminal communication unit 160. The motion recognition result includes a motion type of the object, position information of a rectangular region including the object that is a subject of the recognized motion, and the like. The position information of the object may be, for example, coordinates of each vertex of the rectangular region, and may be a position of the center of the rectangular region or a position of an arbitrary point of the object. The rectangular region is a bounding box or an object region. Note that the object region including the object is not limited to the rectangular region, and may be a region having a circular or amorphous silhouette, or the like. The object indicated by the motion recognition result is, for example, a person who is a target of motion recognition, and may include the work object used by the person in the work. Furthermore, the motion recognition result may include a score of the motion type. The score of the motion type is certainty of the recognized motion type, that is, reliability or a certainty level.

The frame rate determination unit 130 determines the substantial frame rate of each region in the input video based on the motion recognition result acquired from the center server 200. The frame rate determination unit 130 determines the substantial frame rates of the object region indicated by the motion recognition result, that is, the rectangular region, and other regions based on the position information and the motion type of the object indicated by the motion recognition result. Furthermore, a size of the object region for which the substantial frame rate is determined according to the motion recognition result may be changed according to the score of the motion type. For example, the object region may be increased in size as the score of the motion type decreases. In a case where the score of the motion type is low, there is a possibility that the motion type and the position information of the motion recognition result are not correctly recognized, and there is a possibility that the object is not included in the region. Therefore, in a case where the score of the motion type is low, the region whose substantial frame rate is to be controlled can be determined according to the motion recognition result by increasing the size of the object region in consideration of a possibility that the position information of the motion recognition result has not been correctly recognized.

The frame rate determination unit 130 determines the substantial frame rate of the object region based on the motion type indicated by the motion recognition result. For example, the frame rate associated with the motion type is determined as the substantial frame rate of the object region by referring to a motion-frame rate association table stored in the storage unit 170. The frame rate associated with the motion type may have a certain range such as 15 fps to 30 fps. Furthermore, the substantial frame rate may be determined according to a situation of the networks NW1 and NW2. For example, the substantial frame rate of the object region may be determined to be a high frame rate based on the motion type, and the substantial frame rates of other regions may be determined to be a low frame rate or the high frame rate. In addition, the low frame rate may be determined as the substantial frame rate of the object region based on the motion type, and the low frame rate or the high frame rate may be determined as the substantial frame rates of other regions. Note that the high frame rate may be the frame rate of the input video, that is, the video captured by the camera, and may mean a state in which the frame rate of the region with the high frame rate is higher than the frame rates of other regions. The low frame rate is a frame rate lower than the high frame rate, and is, for example, a frame rate lower than the frame rate of the input video.

The frame rate control unit 140 controls the substantial frame rate of the acquired input video. The frame rate control unit 140 controls the substantial frame rate of each region of the input video according to the substantial frame rate of each region determined by the frame rate determination unit 130. For example, in a case where the high frame rate is determined as the substantial frame rate of the specific region, the frame rate control unit 140 may maintain the substantial frame rate of the input video without changing a content of the specific region. Furthermore, in a case where the high frame rate is determined as the substantial frame rate of the specific region, the frame rate control unit 140 may control the substantial frame rate of the specific region to be higher than the substantial frame rate of a region other than the specific region. Furthermore, in a case where the low frame rate is determined as the substantial frame rate of the specific region, the frame rate control unit 140 controls the substantial frame rate of the specific region to be the low frame rate by copying the content of the specific region of the previous frame to the next frame according to the frame rate. As a result, the substantial frame rate of the region with the low frame rate is made lower than the substantial frame rate of the region with the high frame rate, and the substantial frame rate of the region with the high frame rate is made higher than the substantial frame rate of the region with the low frame rate.

The encoder 150 encodes the input video in which the substantial frame rate is controlled. The encoder 150 is an encoding unit that encodes the input video. The encoder 150 is also a compression unit that compresses the input video by a predetermined encoding method. The encoder 150 performs encoding by a video encoding method such as H.264 or H.265, for example.

The encoder 150 encodes the input video input at a predetermined encoding frame rate at a predetermined bit rate. The encoder 150 may encode the input video at a bit rate assigned from the compression bit rate control function 401 of the MEC 400. In addition, the encoder 150 may determine the bit rate based on a communication quality between the terminal 100 and the center server 200. The communication quality is, for example, a communication speed, and may be another indicator such as a transmission delay or an error rate. The terminal 100 may include a communication quality measurement unit that measures the communication quality. For example, the communication quality measurement unit determines the bit rate of the video to be transmitted from the terminal 100 to the center server 200 according to the communication speed. The communication speed may be measured based on a data amount received by the base station 300 or the center server 200, and the communication quality measurement unit may acquire the measured communication speed from the base station 300 or the center server 200. In addition, the communication quality measurement unit may estimate the communication speed based on the data amount per unit time transmitted from the terminal communication unit 160.

Further, the encoder 150 may detect the ROI including the person and encode the input video such that the detected ROI has a higher image quality than those of other regions. The higher image quality means that the image quality is higher than those of other regions. For example, a resolution may be increased to be higher than those of other regions, or a compression rate may be lowered to be lower than those of other regions. For example, an ROI specifying unit may be provided between the video acquisition unit 110 and the encoder 150. The ROI specifying unit detects the object in the acquired video, and specifies the region such as the ROI. The encoder 150 may encode the input video such that the ROI specified by the ROI specifying unit has a higher image quality than those of other regions. In addition, the input image may be encoded such that the image quality of the region designated by the ROI specifying unit is lower than those of other regions. In a case of detecting or specifying the ROI, the ROI specifying unit or the encoder 150 may hold information in which the object that may appear in the video is associated with a priority thereof, and specify the region such as the ROI according to the association information of the priority. The setting of the image quality of the ROI may be realized, for example, by setting an absolute value of a quantization parameter of the region or a difference of the quantization parameter from another region in the encoder. The ROI may be a region different from the object region in which the substantial frame rate is controlled according to the motion recognition result.

The terminal communication unit 160 transmits encoded data encoded by the encoder 150 to the center server 200 via the base station 300. The terminal communication unit 160 is a transmission unit that transmits the video in which the substantial frame rate is controlled. The terminal communication unit 160 is also a reception unit that receives the motion recognition result transmitted from the center server 200 via the base station 300. The terminal communication unit 160 is an interface capable of communicating with the base station 300, and is, for example, a wireless interface such as 4G, local 5G/5G, LTE, or a wireless LAN, and may be a wireless or wired interface of any other communication scheme. The terminal communication unit 160 may include a first terminal communication unit that transmits the encoded data and a second terminal communication unit that receives the motion recognition result. The first terminal communication unit and the second terminal communication unit may be communication units of the same communication scheme, or may be communication units of different communication schemes.

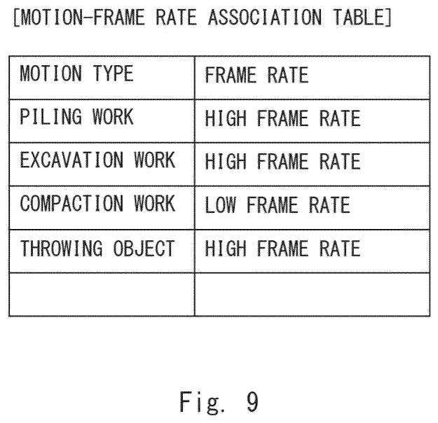

The storage unit 170 stores data necessary for processing in the terminal 100. For example, the storage unit 170 stores the motion-frame rate association table in which the frame rate is associated with the motion type. FIG. 9 illustrates a specific example of the motion-frame rate association table. As illustrated in FIG. 9, in the motion-frame rate association table, the frame rate is associated with the motion type indicated by the motion recognition result. In this example, the high frame rate is associated with piling work, the high frame rate is associated with excavation work, the low frame rate is associated with compaction work, and the high frame rate is associated with a motion of throwing the object. For example, in a case of the compaction work of leveling the ground by a compactor, the compactor itself moves at a high speed, but the video with the high frame rate is unnecessary for motion recognition, and thus the low frame rate is associated with the compaction work. In addition, the video with the high frame rate is required to recognize the motion in which the person throws the object such as a ball, and thus the high frame rate is associated with the motion in which the person throws the object. Note that the frame rate is not limited to the high frame rate and the low frame rate, and may be a plurality of levels of frame rates such as high, medium, and low. The motion type may be associated with not only the level of the frame rate but also a value of the frame rate. The frame rate associated with the motion type may have a certain range such as 15 fps to 30 fps.

Furthermore, as illustrated in FIG. 8, the center server 200 includes a center communication unit 210, a decoder 220, a motion recognition unit 230, and a recognition result notification unit 240.

The center communication unit 210 receives the encoded data transmitted from the terminal 100 via the base station 300. The center communication unit 210 is a reception unit that receives the video in which the substantial frame rate is controlled. Furthermore, the center communication unit 210 is also a transmission unit that transmits the motion recognition result recognized by the motion recognition unit 230 to the terminal 100 via the base station 300. The center communication unit 210 is an interface capable of communicating with the Internet or a core network, and is, for example, a wired interface for IP communication, and may be a wired or wireless interface of any other communication scheme. The center communication unit 210 may include a first center communication unit that receives the encoded data and a second center communication unit that transmits the motion recognition result. The first center communication unit and the second center communication unit may be communication units of the same communication scheme, or may be communication units of different communication schemes.

The decoder 220 decodes the encoded data received from the terminal 100. The decoder 220 is a decoding unit that decodes the encoded data. The decoder 220 is also a restoration unit that restores the encoded data, that is, compressed data, by a predetermined encoding method. The decoder 220 supports an encoding method of the terminal 100, and performs decoding by a moving image encoding method such as H.264 or H.265. The decoder 220 decodes the video according to the compression rate or the bit rate of each region, and generates a decoded video. The decoded video is hereinafter also referred to as a reception video.

The motion recognition unit 230 analyzes the reception video, and recognizes the motion of the object in the reception video. For example, an action of the person such as work performed by the person using the object or an unsafe action in which the person is in a dangerous state is recognized. In addition, not only the action of the person but also the situation of the motion of the object such as an operation situation of machines and a use situation of a work tool may be recognized. The motion recognition unit 230 detects the object from the reception video and recognizes the motion of the detected object. The motion recognition unit 230 recognizes the motion type of the motion of the person who is the target of motion recognition. For example, the motion recognition unit 230 includes an object detection unit 231, a tracking unit 232, a motion predictor 233, and a motion determination unit 234. Note that the object detection unit 231, the tracking unit 232, the motion predictor 233, and the motion determination unit 234 are merely examples, and the motion recognition unit 230 only needs to recognize the type of the motion and the position information such as the rectangular region of the object, and a specific method does not have to be the same as that in the present disclosure.

The object detection unit 231 detects the object in the input reception video. The object detection unit 231 detects the object in each frame included in the reception video and recognizes the type of the detected object. The object detection unit 231 extracts the rectangular region including the object from each frame of the reception video, recognizes the object in the extracted rectangular region, and recognizes the object type of the recognized object. The object detection unit 231 calculates a feature amount of the rectangular region including the object, and recognizes the object based on the calculated feature amount. For example, the object detection unit 231 recognizes the object in the frame by an object recognition engine using machine learning such as deep learning. The object recognition can be performed by machine learning of a feature of a region including the object and the type of the object. The detection result of the object includes the object type, position information of the rectangular region including the object, the score of the object type, and the like. The score of the object type is certainty of the recognized object type, that is, reliability or a certainty level.

The tracking unit 232 tracks the object in the detected reception video. The tracking unit 232 associates the object of each image included in the reception video based on the detection result of the object. By assigning a tracking ID to the detected object, each object can be identified and tracked. For example, the object is tracked by associating the objects between the images based on a distance or overlap between the rectangular region of the object detected in the previous image and the rectangular region of the object detected in the next image.

The motion predictor 233 predicts the motion of the object for each object tracked by the tracking unit 232. The motion predictor 233 recognizes the motion of the object including the person tracked in the reception video, and recognizes the type of the recognized motion. The motion predictor 233 calculates the feature amount of the region including the object, and recognizes the motion type based on the calculated feature amount. For example, the motion predictor 233 recognizes the motion of the object in the reception video by a motion recognition engine using machine learning such as deep learning. The motion of the object can be recognized by machine learning of the video of the object performing the work using the work object and the motion type. Furthermore, the motion predictor 233 outputs the score of the recognized motion type.

The motion determination unit 234 determines the motion of the object based on the predicted motion type. The motion determination unit 234 determines the motion of the object based on scores of a plurality of motion types predicted by the motion predictor 233. For example, the motion determination unit 234 outputs the motion type having the highest score as the recognition result. As the motion recognition result, the motion type, the position information of the object, the score of the motion type, and the like are output.

The recognition result notification unit 240 notifies the terminal 100 of the motion recognition result which is a result of recognizing the motion of the object. The recognition result notification unit 240 transmits the motion recognition result output by the motion determination unit 234 to the terminal 100 via the center communication unit 210. The recognition result notification unit 240 may be incorporated in the center communication unit 210.

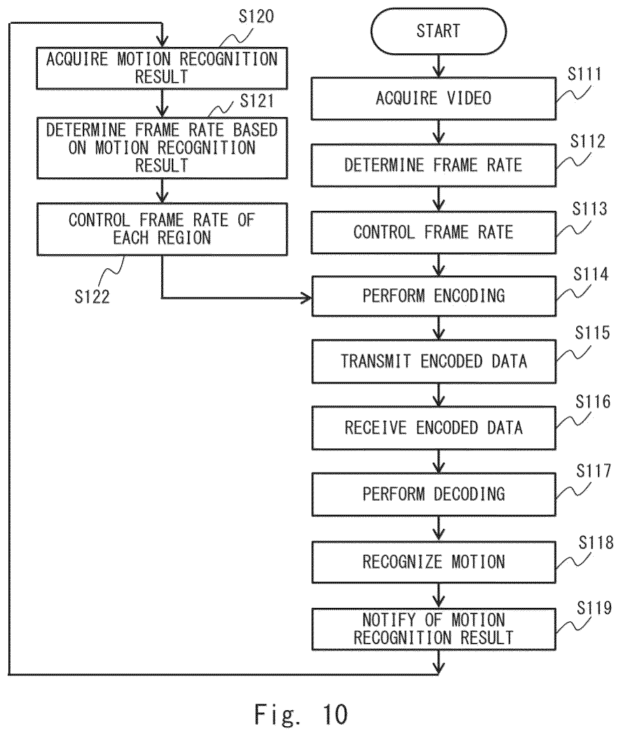

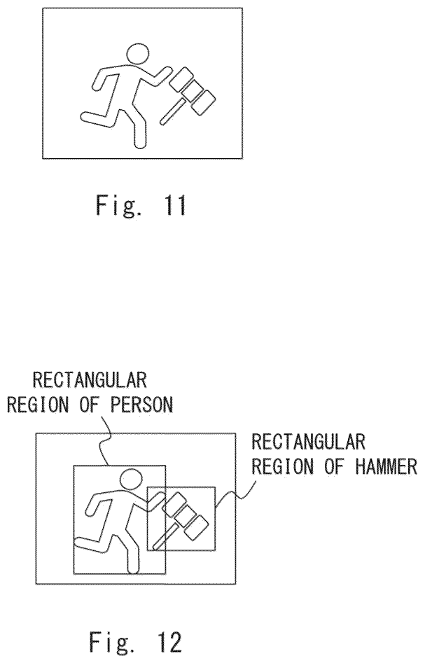

Next, an operation of the remote monitoring system according to the present example embodiment will be described. FIG. 10 illustrates an operation example of the remote monitoring system 1 according to the present example embodiment. For example, description will be made on the assumption that the terminal 100 executes S111 to S115 and S120 to S122, and the center server 200 executes S116 to S119, but the present example embodiment is not limited thereto, and any apparatus may execute each process.

As illustrated in FIG. 10, the terminal 100 acquires the video from the camera 101 (S111). The camera 101 generates the video obtained by capturing the site, and the video acquisition unit 110 acquires the video, that is, the input video output from the camera 101. For example, as illustrated in FIG. 11, the image of the input video includes the person who performs the work in the site and the work object such as a hammer used by the person.

Subsequently, the terminal 100 determines the frame rate of the input video, that is, the substantial frame rate (S112). At this stage, since the center server 200 has not yet recognized the motion from the video, the substantial frame rate is determined without using the motion recognition result. For example, the frame rate determination unit 130 sets the substantial frame rate of the entire region of the video to an initial value. For example, the initial value of the substantial frame rate may be the high frame rate, the low frame rate, or other frame rates. For example, the high frame rate may be the same frame rate as the frame rate of the input video.

Subsequently, the terminal 100 controls the frame rate of the acquired input video, that is, the substantial frame rate (S113). The frame rate control unit 140 controls the substantial frame rate of each region of the input video according to the substantial frame rate of each region determined by the frame rate determination unit 130. In this example, the frame rate of the entire region of the video is controlled to be the high frame rate. For example, in a case where the input video that is not changed has the high frame rate, the input video is input to the encoder 150 without being changed. Note that, in a case where the frame rate of the entire video, that is, the encoding frame rate is changed, the frames may be thinned out or a frame may be inserted, that is, interpolated, according to the frame rate. For example, the same frame as the frame before or after the frame is inserted may be inserted. In the example of FIG. 11, the frame rate of the entire region including the person, the hammer, and other regions is set to the high frame rate.

Subsequently, the terminal 100 encodes the input video in which the frame rate, that is, the substantial frame rate, is controlled (S114). The encoder 150 encodes the input video by a predetermined video encoding method. For example, the encoder 150 may encode the input video at a bit rate allocated from the compression bit rate control function 401 of the MEC 400, or may encode the input video at a bit rate according to the communication quality between the terminal 100 and the center server 200.

Subsequently, the terminal 100 transmits the encoded data to the center server 200 (S115), and the center server 200 receives the encoded data (S116).

The terminal communication unit 160 transmits the encoded data obtained by encoding the input video, to the base station 300. The base station 300 transfers the received encoded data to the center server 200 via the core network or the Internet. The center communication unit 210 receives the transferred encoded data from the base station 300.

Subsequently, the center server 200 decodes the received encoded data (S117). The decoder 220 decodes the encoded data according to the compression rate or the bit rate of each region, and generates the decoded video, that is, the reception video. The decoded reception video is a video that is a target for recognizing the motion of the object, and is the first video captured by the camera 101 at a first timing before the substantial frame rate is controlled according to the motion recognition result and transmitted from the terminal 100.

Subsequently, the center server 200 recognizes the motion of the object based on the decoded reception video (S118). For example, the object detection unit 231, the tracking unit 232, the motion predictor 233, and the motion determination unit 234 of the motion recognition unit 230 recognize the motion of the object including the person in the reception video. Specifically, the object detection unit 231 detects the object in the frame by using the object recognition engine, and outputs the type of the detected object, the position information of the rectangular region including the object, the score of the object type, and the like. The tracking unit 232 assigns the tracking ID to the detected object in the reception video, and tracks the object identified by the tracking ID in each image. The motion predictor 233 predicts the motion of the object from the video including the tracked person or work object by using the motion recognition engine, and outputs the type of the predicted motion, the score of the motion type, and the like. The motion determination unit 234 determines the motion of the object based on the score of the predicted motion type. The motion determination unit 234 outputs the determined motion type, the position information of the object, the score of the motion type, and the like as the motion recognition result.

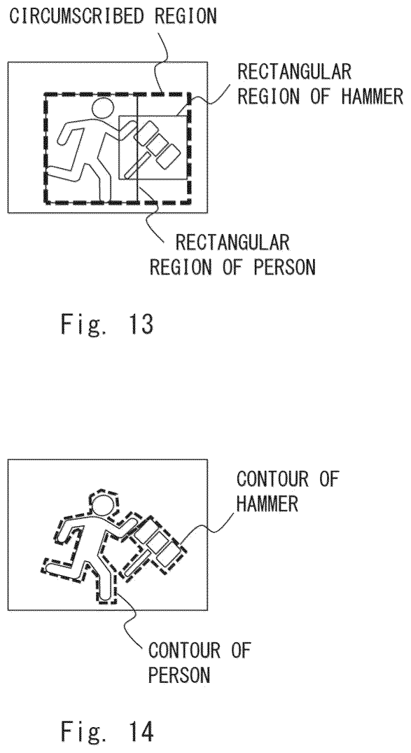

For example, in a case where object detection is performed from the video of FIG. 11, the object detection unit 231 detects the person and the hammer and detects a rectangular region of the person and a rectangular region of the hammer as illustrated in FIG. 12. The tracking unit 232 tracks the detected person and hammer, the motion predictor 233 recognizes the motion of the person based on the videos of the tracked person and hammer, and the motion determination unit 234 outputs the recognized motion type. For example, in a case where the score of the motion type of the piling work is the highest from the videos of the person and the hammer, it is determined that the motion of the person is the piling work.

Subsequently, the center server 200 notifies the terminal 100 of the recognized motion recognition result (S119), and the terminal 100 acquires the motion recognition result (S120). The recognition result notification unit 240 notifies the terminal of the motion recognition result output by the motion determination unit 234 via the center communication unit 210. The center communication unit 210 transmits the motion recognition result to the base station 300 via the Internet or the core network. The base station 300 transfers the received motion recognition result to the terminal 100. The terminal communication unit 160 receives the transferred motion recognition result from the base station 300. The recognition result acquisition unit 120 acquires the motion recognition result received by the terminal communication unit 160.

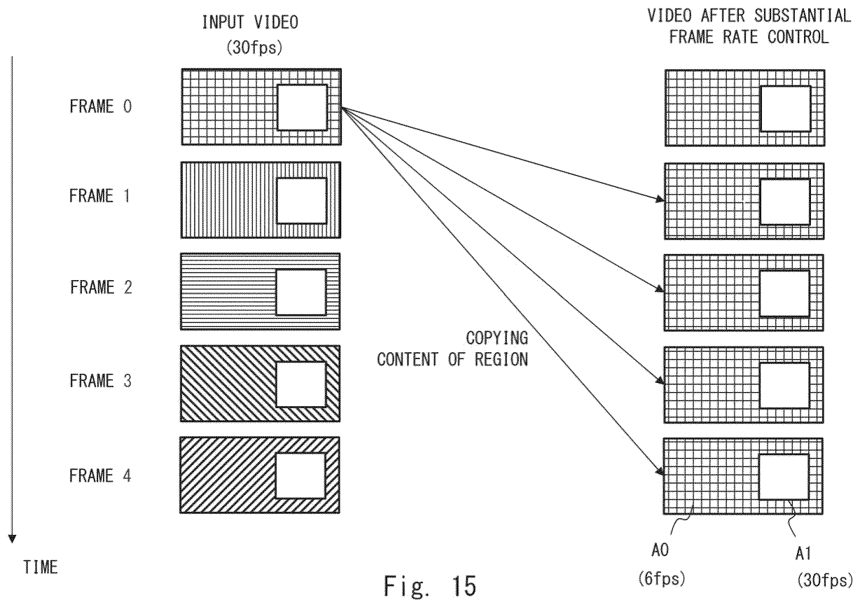

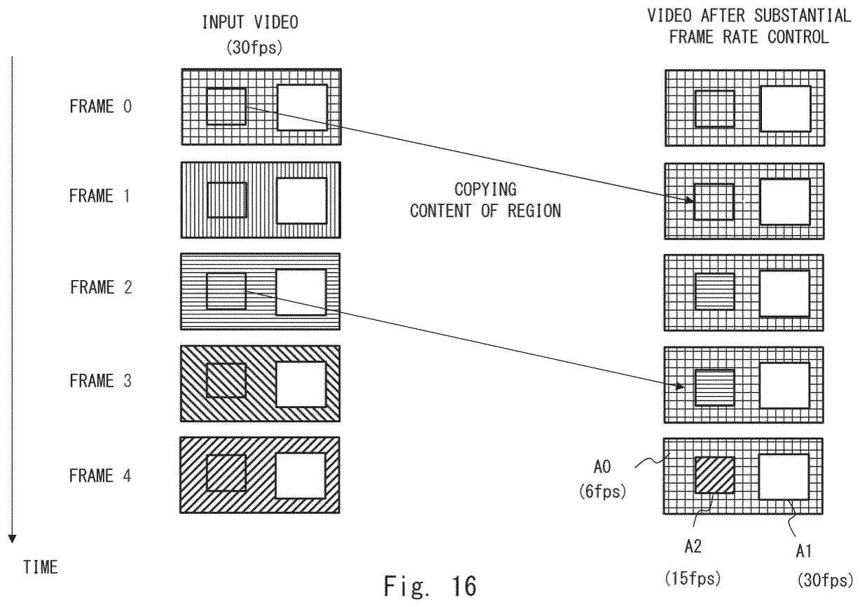

Subsequently, the terminal 100 determines the substantial frame rate for each region of a newly acquired input video based on the motion recognition result acquired from the center server 200 (S121). After S112, the terminal 100 continuously acquires the video from the camera 101, and new videos are acquired before and after S120 and S121, and the frame rate determination unit 130 determines the substantial frame rate of the newly acquired videos. The newly acquired video is a video that is a target for controlling the substantial frame rate according to the motion recognition result, and is the second video captured by the camera 101 at a second timing after the timing for the first video and acquired by the terminal 100. The frame rate determination unit 130 determines the substantial frame rates of the object region and the other region indicated by the motion recognition result. For example, in a case where the motion recognition result indicates the rectangular region of the person and the rectangular region of the hammer as illustrated in FIG. 12, the substantial frame rate may be determined using the rectangular region of the person and the rectangular region of the hammer as the object regions. In addition, as illustrated in FIG. 13, the substantial frame rate may be determined using a circumscribed region including the rectangular region of the person and the rectangular region of the hammer as the object region. In addition, as illustrated in FIG. 14, the substantial frame rate may be determined using regions along contours of the person and the hammer as the object regions. In this case, the center server 200 may notify of information regarding the contours of the person and the hammer as the motion recognition result.

The frame rate determination unit 130 determines the substantial frame rate of the object region indicated by the motion recognition result based on the motion type indicated by the motion recognition result, and further determines the substantial frame rate of the other region. The frame rate determination unit 130 determines the substantial frame rate of the object region by referring to the motion-frame rate association table of the storage unit 170. In the example of the table of FIG. 9, in a case where the motion type is the piling work, the high frame rate associated with the piling work is determined as the substantial frame rate of the object region. In the example of FIG. 12, in a case where the motion type is the piling work, the high frame rate is determined as the substantial frame rate of the object region including the rectangular region of the person and the rectangular region of the hammer. Furthermore, the substantial frame rate of the other region is determined to be a predetermined frame rate, for example, the low frame rate.

Subsequently, the terminal 100 controls the frame rate of each region of the newly acquired input video, that is, the substantial frame rate (S122). The frame rate control unit 140 controls the substantial frame rate of the newly acquired input video according to the substantial frame rate of each region determined by the frame rate determination unit 130. For example, the input video is controlled such that the substantial frame rate of the region determined to have the low frame rate is lower than the substantial frame rate of the region determined to have the high frame rate. In the example of FIG. 12, in a case where the rectangular region of the person and the rectangular region of the hammer are determined to have the high frame rate and the other region are determined to have the low frame rate, the substantial frame rate of the other region may be lowered to set the frame rates of the rectangular region of the person and the rectangular region of the hammer to the high frame rate. For example, in a case where the substantial frame rate of the specific region is lowered, the content of the specific region is copied between previous and subsequent frames according to the frame rate. Since there is no difference between the frames in the region in which the content is copied, the frame rate of the copied region is substantially lowered in the encoded data, and the bit rate can be reduced.

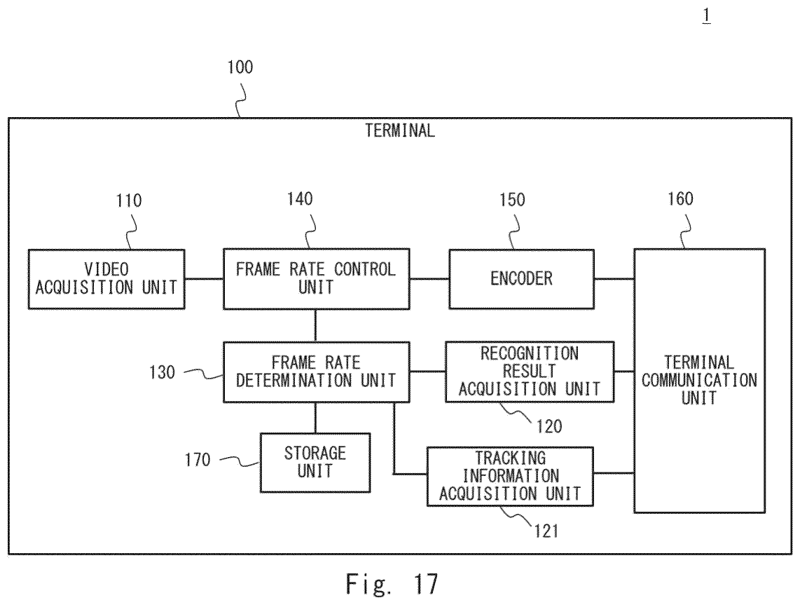

FIG. 15 illustrates an example in which the frame rate of the object region indicated by the motion recognition result is controlled to be the high frame rate, and the frame rate of the other region is controlled to be the low frame rate. FIG. 15 illustrates images of frames 0 to 4 of the input video and frames 0 to 4 after the substantial frame rate control. In each frame, a white square region A1 indicates the object region having the high frame rate, and a region A2 other than the white square indicates the other region having the low frame rate. In the other region A2, the same content is indicated by the same hatching pattern, and different contents are indicated by different hatching patterns. In addition, all the object regions A1 are indicated by a white square, but actually includes the object, and the content thereof is different for each frame. In the example of FIG. 15, in the object region A1 of the video after the substantial frame rate control, the content of the object region A1 is not changed using the contents of the frames 0 to 4 of the input video. In the other region A0, the content of the specific frame is copied to the subsequent frame according to the substantial frame rate. For example, by copying the content of the other region A0 of the frame 0 to the frames 1 to 4, the content of the other region A0 is made the same for every five consecutive frames. As a result, the substantial frame rate of the other region AO can be made lower than that of the object region A1 by ⅕. For example, in a case where the substantial frame rate of the object region A1 is 30 fps which is the same as the encoding frame rate, the substantial frame rate of the other region A0 is 6 fps.

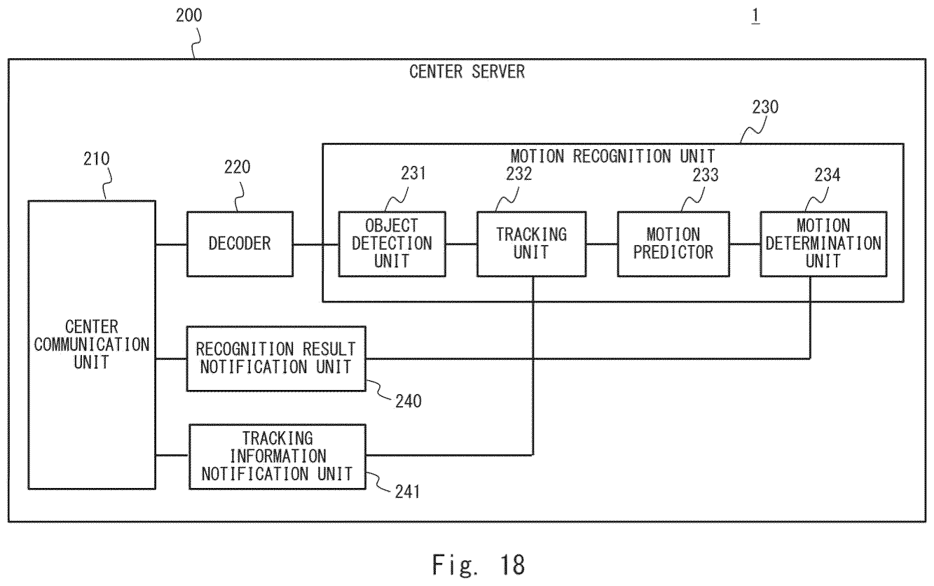

FIG. 16 illustrates an example in which a frame rate of a first object region indicated by the motion recognition result is controlled to be the high frame rate, a frame rate of a second object region indicated by the motion recognition result is controlled to be the medium frame rate, and a frame rate of the other region is controlled to be the low frame rate. Similarly to FIG. 15, FIG. 16 illustrates the images of frames 0 to 4 of the input video and the frames 0 to 4 after the substantial frame rate control. The first object region A1 and the other region A0 of each frame are illustrated similarly to FIG. 15. The second object region A2 in which the frame rate is controlled to be the medium frame rate is a square area different from the first object region A1, and different contents are indicated by different hatching patterns similarly to the other region A0. In the example of FIG. 16, in the first object region A1, the content is not changed in the video after the substantial frame rate control, and in the second object region A2 and the other region A0, the content of the specific frame is copied to the subsequent frame according to each of the substantial frame rates. For example, the content of the second object region A2 of the frame 0 is copied to the frame 1, and the content of the second object region A2 of the frame 2 is copied to the frame 3, so that the second object region A2 has the same content every two consecutive frames. For the other region A0, the content of the frame 0 is copied to the frames 1 to 4 similarly to FIG. 15. As a result, the substantial frame rate of the second object region A2 can be lower than that of the first object region A1 by ½, and the substantial frame rate of the other region A0 can be lower than that of the first object region A1 by ⅕. For example, in a case where the substantial frame rate of the first object region A1 is 30 fps which is the same as the encoding frame rate, the substantial frame rate of the second object region A2 is 15 fps, and the substantial frame rate of the other region A0 is 6 fps. Then, in the flowchart of FIG. 10, the processing from S114 is repeatedly performed.

As described above, in the present example embodiment, the center server notifies the terminal of the motion recognition result including the motion type and the object region, and the substantial frame rate of each region of the video is controlled according to the motion type and the object region. For example, a relationship between the motion type and the frame rate is determined in advance, and the substantial frame rate is determined according to the motion type recognized from the video. As a result, the substantial frame rate can be appropriately controlled according to the motion recognized by the center server. For example, in a case where the motion can be recognized at the low frame rate even if the motion of the object is fast, the substantial frame rate of the region of the object to be recognized can be lowered. Therefore, the data amount of the encoded data, that is, the bit rate, can be reduced while maintaining the motion recognition accuracy.

### First Modified Example of First Example Embodiment

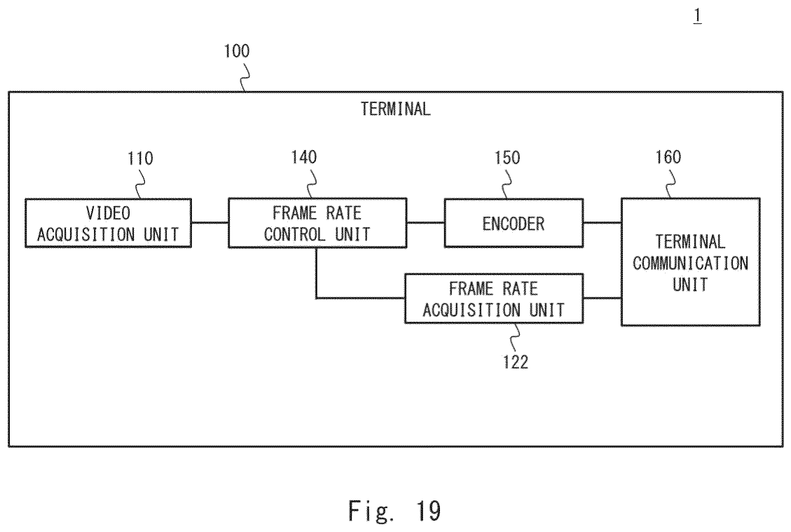

As a first modified example of the first example embodiment, the substantial frame rate of the video may be controlled based on tracking information obtained by tracking the object. FIG. 17 illustrates a configuration example of a terminal 100 according to the first modified example of the first example embodiment, and FIG. 18 illustrates a configuration example of a center server 200 according to the first modified example of the first example embodiment.

As illustrated in FIG. 17, the terminal 100 may include a tracking information acquisition unit 121 in addition to the configuration of the first example embodiment. As illustrated in FIG. 18, the center server 200 may include a tracking information notification unit 241 in addition to the configuration of the first example embodiment. Note that the tracking information acquisition unit 121 may be included instead of the recognition result acquisition unit 120 of the terminal 100, and the tracking information notification unit 241 may be included instead of the recognition result notification unit 240 of the center server 200. The tracking information notification unit 241 may be incorporated in a center communication unit 210.

In the present modified example, the tracking information notification unit 241 of the center server 200 notifies the terminal 100 of the tracking information obtained by tracking processing of a tracking unit 232 via the center communication unit 210. The tracking information is information indicating a movement trajectory of the object which is a result of tracking the object.

The tracking information acquisition unit 121 of the terminal 100 acquires the tracking information received from the center server 200 via a terminal communication unit 160. Note that the tracking information acquisition unit 121 may be incorporated in the terminal communication unit 160. A frame rate determination unit 130 may determine the substantial frame rate of a region based on the acquired tracking information. For example, the substantial frame rate of the region positioned at an end of the extending movement trajectory of the tracking information may be determined. A size of the object region for which the substantial frame rate is determined according to the motion recognition result may be changed according to a movement amount of the tracking information. For example, the object region may be increased in size as the movement amount increases. The frame rate determination unit 130 may determine the substantial frame rate of the region based on the tracking information according to the motion type, or may determine the substantial frame rate of the object region indicated by the motion recognition result according to the motion type, similarly to the first example embodiment.

In this manner, the substantial frame rate of the video may be controlled based on the tracking information of the object without being limited to the motion recognition result of the video. As a result, the substantial frame rate can be more appropriately controlled. For example, in a case where another object is detected in a region predicted from the movement trajectory of the object, or in a case where a trajectory of the object and a trajectory of the other object intersect each other, there is a possibility of a dangerous state. Therefore, the substantial frame rate of the region predicted from the movement trajectory of the object can be controlled to be the high frame rate. Note that the center server 200 may detect the region predicted from the movement trajectory of the object and notify the terminal 100 of the detection result.

### Second Modified Example of First Example Embodiment

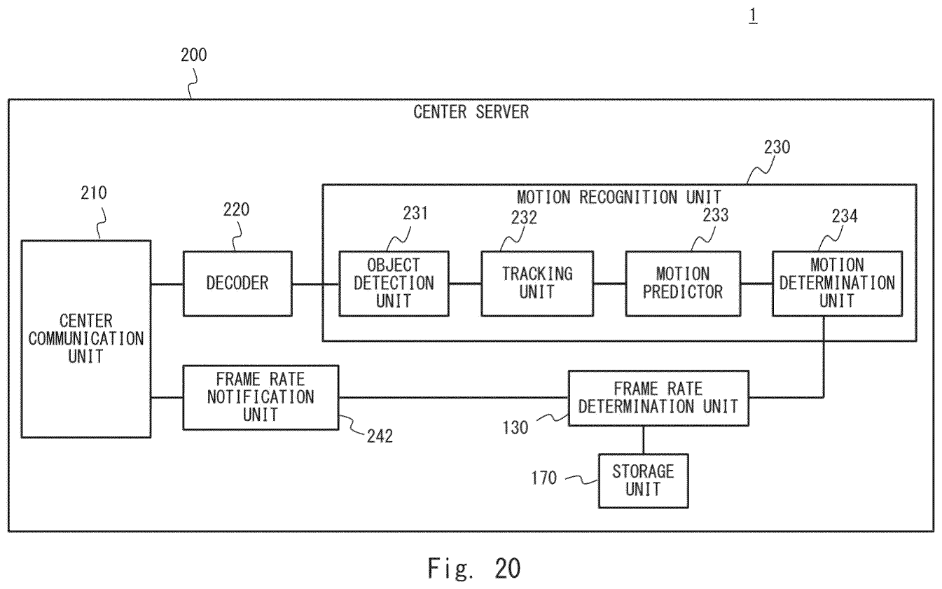

As a second modified example of the first example embodiment, the center server may determine the substantial frame rate. FIG. 19 illustrates a configuration example of a terminal 100 according to the second modified example of the first example embodiment, and FIG. 20 illustrates a configuration example of a center server 200 according to the second modified example of the first example embodiment.

As illustrated in FIG. 19, the terminal 100 may include a frame rate acquisition unit 122 instead of the recognition result acquisition unit 120 without including the frame rate determination unit 130 and the storage unit 170 of the first example embodiment. As illustrated in FIG. 20, the center server 200 may include the frame rate determination unit 130 and the storage unit 170 of the terminal 100 in the first example embodiment, and may include a frame rate notification unit 242 instead of the recognition result notification unit 240. The frame rate notification unit 242 may be incorporated in a center communication unit 210.

In the present modified example, the frame rate determination unit 130 of the center server 200 determines the frame rate based on the motion recognition result recognized by a motion determination unit 234. Similarly to the first example embodiment, the frame rate determination unit 130 determines the substantial frame rate of the region based on the position information of the object of the motion recognition result based on the motion type of the motion recognition result. The frame rate notification unit 242 notifies the terminal 100 of frame rate control information including the substantial frame rate of each region determined by the frame rate determination unit 130 via the center communication unit 210.

The frame rate acquisition unit 122 of the terminal 100 acquires the frame rate control information received from the center server 200 via a terminal communication unit 160. Note that the frame rate acquisition unit 122 may be incorporated in the terminal communication unit 160. The frame rate control unit 140 controls the substantial frame rate of each region of the input video based on the frame rate control information acquired by the frame rate acquisition unit 122 from the center server 200.

In this manner, the center server may determine the substantial frame rate according to the motion recognition result and notify the terminal of the determined substantial frame rate. Even in this case, the substantial frame rate can be appropriately controlled similarly to the first example embodiment.

### Third Modified Example of First Example Embodiment

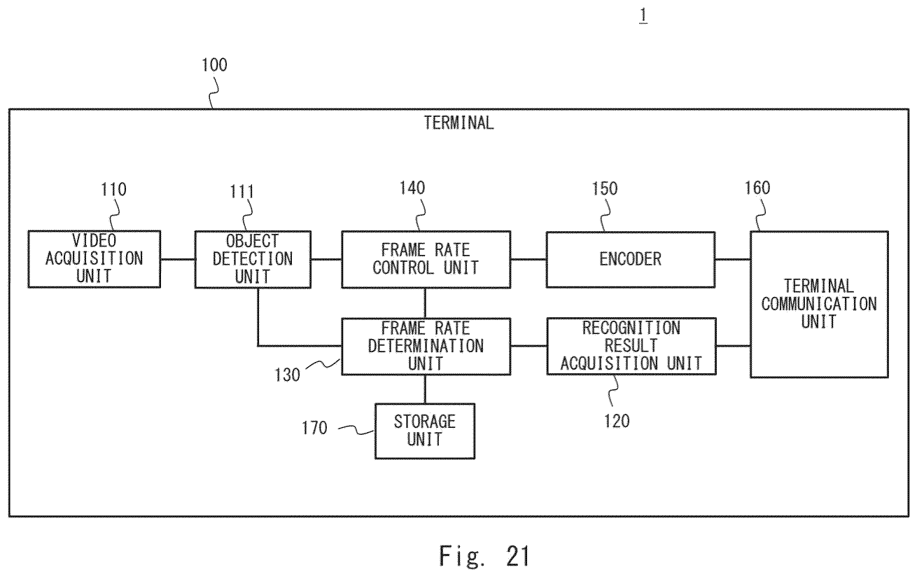

As a third modified example of the first example embodiment, the terminal may perform object detection. FIG. 21 illustrates a configuration example of a terminal 100 according to the third modified example of the first example embodiment. Note that a configuration of a center server 200 is similar to that of the first example embodiment. As illustrated in FIG. 21, the terminal 100 may further include an object detection unit 111 in addition to the configuration of the first example embodiment.

In the present modified example, the object detection unit 111 detects the object in the acquired input video. For example, similarly to an object detection unit 231 of the center server 200, the object detection unit 111 recognizes the object by an object recognition engine using machine learning. Note that the object recognition engine of the object detection unit 111 may be an object recognition engine that performs learning different from an object recognition engine included in the object detection unit 231. The object detection unit 111 extracts the rectangular region including the object from each image of the input video, and recognizes the object type of the object in the extracted rectangular region. The detection result of the object includes the object type, position information of the rectangular region including the object, the score of the object type, and the like.

A frame rate determination unit 130 determines the substantial frame rate of the input video based on the detection result of the object detected in the input video. For example, the substantial frame rate may be determined based on the object detection result before receiving the motion recognition result from the center server 200. After receiving the motion recognition result from the center server 200, the substantial frame rate may be determined using either the object detection result or the motion recognition result. In a case of using the object detection result, the frame rate determination unit 130 determines the substantial frame rate of the region based on the position information of the object having a predetermined object type among the detected objects detected in the input video. For example, a target object type may be stored in a storage unit 170, and the substantial frame rate of the region of the object having the stored object type may be determined. In addition, a list of pairs of target objects such as the person and the work object may be stored in the storage unit 170, and substantial frame rates of regions of a first object and a second object having the stored object type of the pair of target objects may be determined. The substantial frame rates noof the regions of the first object and the second object in a predetermined positional relationship may be determined. In addition, a substantial frame rate of a region of the object whose score of the object type included in the object detection result is higher than a predetermined value or substantial frame rates of regions of a predetermined number of objects with the highest scores of the object type may be determined. Note that the substantial frame rate of the region of the object whose score of the object type is lower than the predetermined value may be determined. The frame rate determination unit 130 may determine the high frame rate as the substantial frame rate of the object region based on the object detection result. The frame rate may be associated with the object type, and the substantial frame rate may be determined according to the object type of the detected object. Note that a method of determining the substantial frame rate based on the detection result of the object in the present example embodiment may be used for determining the substantial frame rate in S112 in FIG. 10. In this case, since the substantial frame rate can be controlled according to the type of the detected object even before the motion recognition result is obtained, the high frame rate can be assigned to the region including the object with a high importance, and the motion can be appropriately recognized.

As described above, the substantial frame rate may be controlled according to the detection result of the object without being limited to the motion recognition result of the video. As a result, the substantial frame rate can be more appropriately controlled. For example, the frame rate of the region of the person, the work, or the like that is a recognition target of the center server can be controlled to be the high frame rate.

### Fourth Modified Example of First Example Embodiment

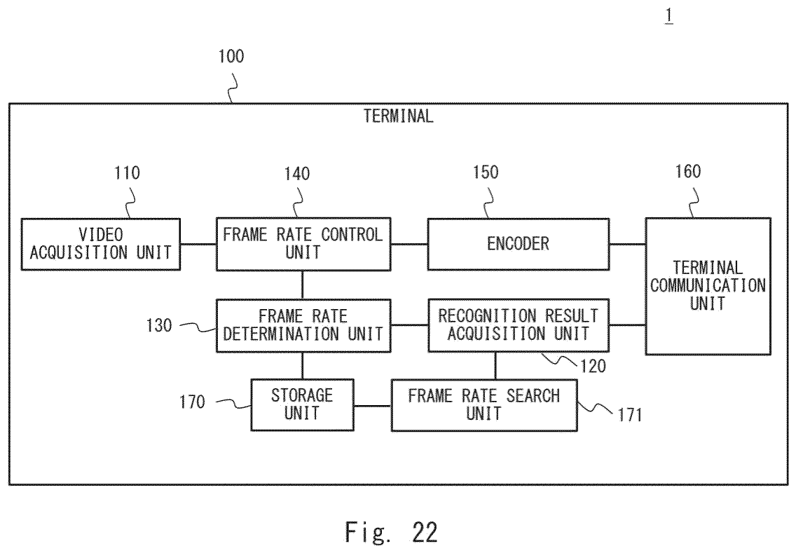

As a fourth modified example of the first example embodiment, an optimal frame rate may be searched for each motion. FIG. 22 illustrates a configuration example of a terminal 100 according to the fourth modified example of the first example embodiment. Note that a configuration of a center server 200 is similar to that of the first example embodiment. As illustrated in FIG. 22, the terminal 100 may further include a frame rate search unit 171 in addition to the configuration of the first example embodiment.

In the present modified example, the frame rate search unit 171 determines the frame rate that is optimum for the motion based on the substantial frame rate controlled by a frame rate control unit 140 and the motion recognition result acquired by a recognition result acquisition unit 120. For example, a video of a predetermined motion is input to the terminal 100, and the frame rate control unit 140 changes the substantial frame rate of the video from, for example, a lower limit to an upper limit or from the upper limit to the lower limit within a predetermined range. The upper limit and the lower limit of the predetermined range may be preset values or may be values that can reduce a delay at the time of video transmission derived from the current situation of the network. The center server 200 recognizes the motion from the video with each frame rate, and notifies the terminal 100 of the recognized motion recognition result. The recognition result acquisition unit 120 acquires the motion recognition result of each frame rate from the center server 200. The frame rate search unit 171 determines the frame rate at which the score of the motion type is the highest as the optimum frame rate of the recognized motion by referring to the score of the motion type included in the motion recognition result of each frame rate. The minimum frame rate at which the score is equal to or higher than a specified value may be set as the optimum frame rate. The frame rate search unit 171 stores the determined optimum frame rate and the motion type in association with each other in the motion-frame rate association table of the storage unit 170.

In this manner, the optimum frame rate may be searched for each motion based on the recognition result actually obtained from the video with each frame rate. By using a relationship between the motion type and the frame rate obtained by the search, the substantial frame rate can be appropriately controlled for each motion type.

### Second Example Embodiment

Next, a second example embodiment will be described. In the present example embodiment, an example of controlling a substantial frame rate of a video according to a motion vector of the video will be described.

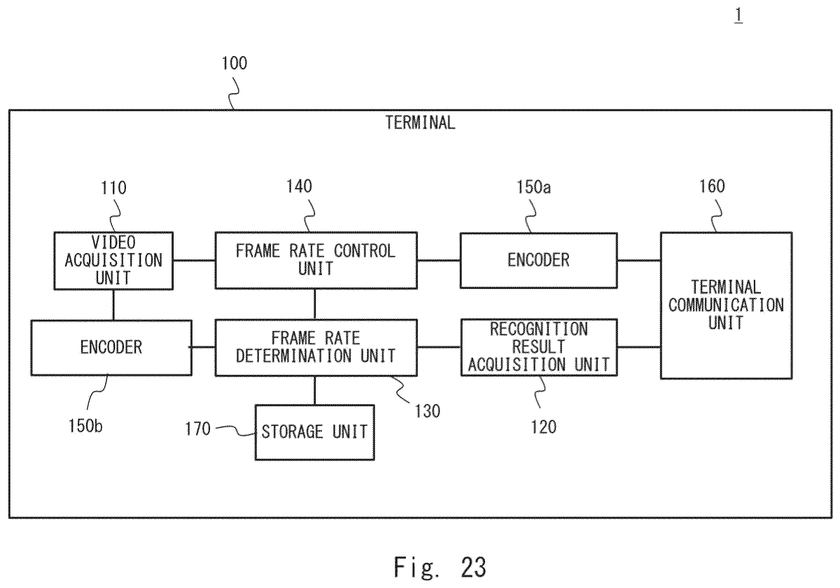

FIG. 23 illustrates a configuration example of a terminal 100 according to the present example embodiment. Note that a configuration of a center server 200 is similar to that of the first example embodiment. As illustrated in FIG. 23, the terminal 100 according to the present example embodiment includes an encoder 150b in addition to the configuration of the first example embodiment. Note that an encoder 150a is the encoder 150 of the first example embodiment, and is an encoder that encodes an input video for distribution. For example, the encoder 150a is a first encoder, and the encoder 150b is a second encoder.

The encoder 150b is an encoder for detecting the motion vector of the input video, and is a motion vector detection unit. The encoder 150b is the same encoder as the encoder 150a, and encodes the input video by a video encoding method such as H.264 or H.265. Similarly to the first example embodiment, a video acquisition unit 110 continuously acquires the input video input from a camera 101, and the encoder 150b detects the motion vector from the continuously acquired input video. For example, the encoder 150b may detect the motion vector from a first video captured at a first timing before controlling a substantial frame rate according to a motion recognition result in the first example embodiment, may detect the motion vector from a second video captured at a second timing after the first timing and in which the substantial frame rate is controlled according to the motion recognition result, or may detect the motion vector from a third video captured at a subsequent third timing.

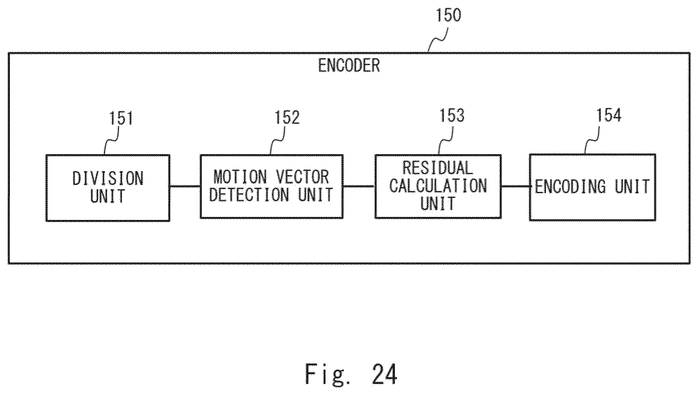

FIG. 24 illustrates a configuration example of the encoder 150 including the encoders 150a and 150b. As illustrated in FIG. 24, for example, the encoder 150 includes a division unit 151, a motion vector detection unit 152, a residual calculation unit 153, and an encoding unit 154.

The division unit 151 divides the input video into coding blocks of a predetermined size. The coding block is a coding processing unit, and is a coding tree unit (CTU) and a coding unit (CU) in a case of H.265. For example, the division unit 151 divides the input video into CTUs of 64×64 pixels, and recursively and repeatedly divides the input video into CUs with a size of ¼ according to an image.

The motion vector detection unit 152 detects the motion vector from a prediction unit (PU) included in each divided coding block CU. The motion vector indicates a magnitude of movement related to each region of a frame of the video, and indicates a movement direction and a movement amount of a pixel with respect to the current target frame from a previous reference frame. The reference frame is a frame to be referred to for calculating the motion vector, and may be an immediately previous frame or a frame before a predetermined period. For example, the motion vector detection unit 152 searches for a block matching a block of the reference frame from the target frame, and calculates the movement direction and the movement amount of the searched block.

The residual calculation unit 153 applies the motion vector to the previous reference frame for each coding block to calculate a residual that is a difference between a prediction reference frame in which movement of the pixel in the video is predicted and the current target frame in which the motion vector is detected, that is, an input frame. The residual is a difference between a prediction frame in which the motion of the frame input next to the reference frame is predicted by applying the motion vector, and the frame input next to the reference frame. The encoding unit 154 encodes the reference frame, the motion vector, and the residual for each coding block, and generates encoded data of the target frame. Note that the encoder 150b only needs to be able to detect the motion vector, and thus may include only the division unit 151 and the motion vector detection unit 152. In addition, the motion vector is included only in a frame that is encoded with reference to another frame. Therefore, the encoder 150b may be set to perform encoding with reference to another frame in all frames except the head frame.

In the present example embodiment, a frame rate determination unit 130 determines the substantial frame rate of the input video based on the motion vector detected by the motion vector detection unit 152 of the encoder 150b. The motion vector is detected in units of PUs included in one or two coding blocks. The substantial frame rate may be determined for each coding block from an average value of the motion vectors included in each PU, and values such as a weighted average, a maximum value, and a minimum value according to a PU size. For example, the frame rate determination unit 130 may determine the substantial frame rate based on the motion vector detected from the first video before receiving the motion recognition result from the center server 200, and a frame rate control unit 140 may control the substantial frame rate of the first video. The frame rate determination unit 130 may determine the substantial frame rate by using one of the motion vector detected from the second video and the motion recognition result after receiving the motion recognition result from the center server 200, and the frame rate control unit 140 may control the substantial frame rate of the second video. The frame rate determination unit 130 may determine the substantial frame rate based on the motion vector detected from the subsequent third video, and the frame rate control unit 140 may control the substantial frame rate of the third video.

For example, the frame rate determination unit 130 determines the substantial frame rate of the coding block having the motion vector other than 0 or the coding block having the motion vector larger than a predetermined value. The region for which the substantial frame rate is determined may be a region in which the motion is estimated from the motion vector. For example, the frame rate determination unit 130 may determine the substantial frame rate of the region including the periphery of the coding block having the motion vector other than 0. The frame rate determination unit 130 may change a size of the region for which the substantial frame rate is determined according to a size of the motion vector. For example, the frame rate determination unit 130 may increase the size of the region for which the substantial frame rate is determined as the motion vector increases. The frame rate determination unit 130 may move the region for which the substantial frame rate is determined according to the movement direction of the motion vector.

The frame rate determination unit 130 may determine, for example, a high frame rate as the substantial frame rate of the region based on the motion vector. The substantial frame rate may be changed according to the size of the motion vector. For example, the substantial frame rate may be increased as the motion vector increases. In a case of H.265, since a size of the CU of the coding block changes according to a motion of a content of the image, the substantial frame rate may be changed according to the size of the coding block. For example, the substantial frame rate may be increased as the coding block becomes smaller. Note that the description of units that operate as in FIG. 7 in the first example embodiment is omitted.

As described above, in the present example embodiment, in addition to the configuration of the first example embodiment, the substantial frame rate of the video is further controlled according to the motion vector of the video. For example, a speed of the motion of each region is detected from the motion vector detected by the terminal, and the substantial frame rate is set to the high frame rate only for a portion in which the motion is fast. As a result, the substantial frame rate can be appropriately controlled according to the motion of the object. For example, it is possible to reduce a recognition failure in a case where the object starts the motion. Furthermore, for example, even in a case where a motion requiring a video with the high frame rate for motion recognition is started, recognition accuracy can be improved. That is, even in a case where the frame rate of the region of the object is set to a low frame rate according to the motion recognition result of the center server as in the first example embodiment, it is possible to prevent the recognition failure by setting the region of the moving object according to the motion vector to the high frame rate on the terminal side.

### First Modified Example of Second Example Embodiment

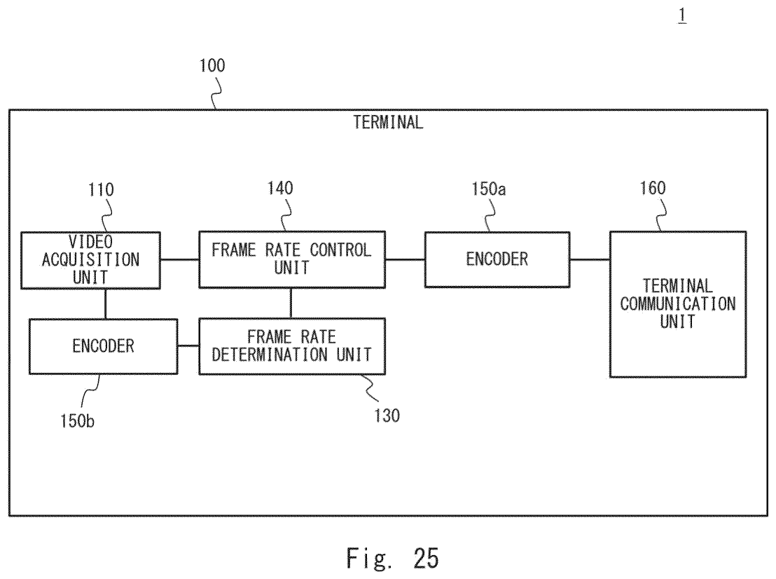

As a first modified example of the second example embodiment, the substantial frame rate of the video may be controlled according to only the motion vector of the video. FIG. 25 illustrates a configuration example of a terminal 100 according to the first modified example of the second example embodiment. As illustrated in FIG. 25, the terminal 100 does not have to include a recognition result acquisition unit 120 and a storage unit 170 included in the configuration of FIG. 23. That is, the terminal 100 may include only a video acquisition unit 110, a frame rate determination unit 130, a frame rate control unit 140, an encoder 150a, an encoder 150b, and a terminal communication unit 160. Even in this case, similarly to the second example embodiment, the substantial frame rate can be appropriately controlled according to the motion vector.

### Second Modified Example of Second Example Embodiment

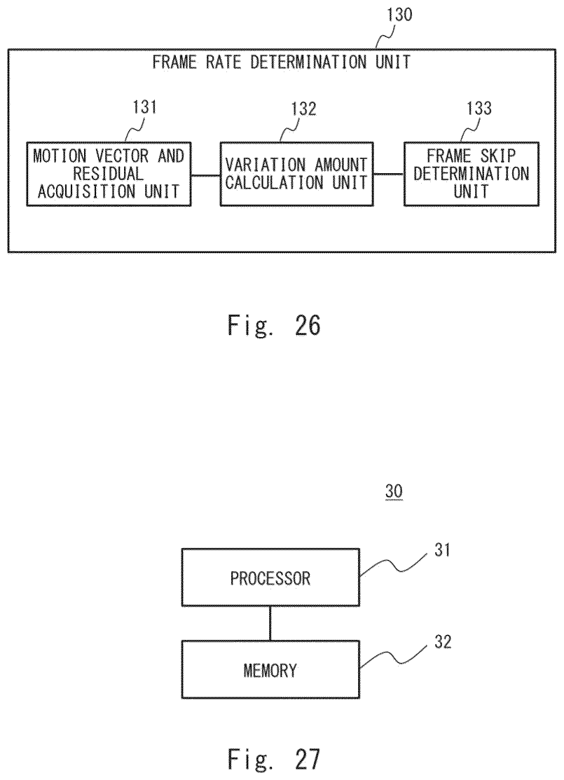

As a modified example of the second example embodiment, frame skip may be controlled according to variation amounts of the motion vector and the residual. A configuration of a terminal 100 is similar to that of the second example embodiment. FIG. 26 illustrates a configuration example of a frame rate determination unit according to a second modified example of the second example embodiment. In the present modified example, a frame rate determination unit 130 controls the substantial frame rate by determining the frame skip of the input video based on the motion vector and the residual.

As illustrated in FIG. 26, the frame rate determination unit 130 includes a motion vector and residual acquisition unit 131, a variation amount calculation unit 132, and a frame skip determination unit 133. The motion vector and residual acquisition unit 131 acquires the motion vector detected by a motion vector detection unit 152 of an encoder 150b and the residual calculated by a residual calculation unit 153 of an encoder 150b. The motion vector and residual acquisition unit 131 acquires the motion vector and the residual for each coding block.

The variation amount calculation unit 132 calculates the total variation amount of the acquired motion vector and residual. For example, a function d=f(MV, residual, . . .) representing the total variation amount which is a scalar variation amount of the motion vector (MV) and the residual between the frames is defined in advance, and the total variation amount is calculated by the function d. The variation amount calculation unit 132 calculates the total variation amount for each coding block.

The frame skip determination unit 133 determines whether or not it is necessary to perform the frame skip of the input video based on the calculated total variation amount. For example, in a case where the total variation amount is smaller than a threshold, it is determined that the frame skip is necessary, and in a case where the total variation amount is larger than the threshold, it is determined that the frame skip is unnecessary. For example, in a case where a cumulative value Σd from the frame most recently input from a frame rate control unit 140 to an encoder 150a exceeds a threshold, it may be determined that the frame skip is unnecessary. The frame skip determination unit 133 determines whether or not the frame skip is necessary for each coding block.

The frame rate control unit 140 controls the frame skip of the input video based on a determination result of the frame skip determination unit 133. The frame rate control unit 140 may skip the frame for which it is determined that the frame skip is necessary among the frames of the input video, that is, may thin out the frames from the input video, or may copy a content of the immediately previous frame. The frame rate control unit 140 does not input the frame for which it is determined that the frame skip is necessary to the encoder 150a, and inputs the frame for which it is determined that the frame skip is unnecessary to the encoder 150a. In a case where it is determined whether or not the frame skip is necessary for each coding block, a content of the coding block for which it is determined that the frame skip is unnecessary is not changed, and a frame obtained by copying the content from the previous frame is input to the encoder 150a for the coding block for which it is determined that the frame skip is necessary.

As described above, by controlling skipping of the frame and the content of each region according to the variation amounts of the motion vector and the residual, the frame can be skipped according to the motion of the object, so that the data amount of the encoded data can be further reduced.

Note that the present disclosure is not limited to the above-described example embodiments, and can be appropriately modified without departing from the scope.

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 27. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system including:
motion recognition means for recognizing a motion of an object included in a first video captured by a sensor; and control means for controlling a change in a display content for each frame of a second video captured by the sensor for each region in the second video according to a recognition result of the motion.

### Supplementary Note 2

The video processing system according to Supplementary Note 1, in which the control means controls the change in the display content of the frame of the second video by copying, to a predetermined region of a first frame included in the second video, a content of the predetermined region of a frame before the first frame.

### Supplementary Note 3

The video processing system according to Supplementary Note 1 or 2, in which the recognition result of the motion includes a type of the motion of the object.

### Supplementary Note 4

The video processing system according to any one of Supplementary Notes 1 to 3, in which
the recognition result of the motion includes position information of the object, and
the control means controls the change in the display content of a region including a region corresponding to the position information of the object or a region other than the region including the region corresponding to the position information of the object.

### Supplementary Note 5

The video processing system according to any one of Supplementary Notes 1 to 4, further including motion vector detection means for detecting a motion vector indicating a magnitude of movement related to each region of the frame of the second video from the second video,
in which the control means controls the change in the display content for each region in the second video according to the detected motion vector.

### Supplementary Note 6

The video processing system according to Supplementary Note 5, further including:
a first encoder configured to encode the second video in which the change in the display content is controlled; and
a second encoder including the motion vector detection means.

### Supplementary Note 7

The video processing system according to Supplementary Note 6, in which
the second encoder calculates a difference between a prediction frame, in which a motion of a frame input next to a second frame is predicted by applying the motion vector, and the frame input next to the second frame, and
the control means controls the change in the display content for each region in the second video based on the motion vector and the difference.

### Supplementary Note 8

A video processing apparatus including:
motion recognition means for recognizing a motion of an object included in a first video captured by a sensor; and control means for controlling a change in a display content for each frame of a second video captured by the sensor for each region in the second video according to a recognition result of the motion.

### Supplementary Note 9

The video processing apparatus according to Supplementary Note 8, in which the control means controls the change in the display content of the frame of the second video by copying, to a predetermined region of a first frame included in the second video, a content of the predetermined region of a frame before the first frame.

### Supplementary Note 10

The video processing apparatus according to Supplementary Note 8 or 9, in which the recognition result of the motion includes a type of the motion of the object.

### Supplementary Note 11

The video processing apparatus according to any one of Supplementary Notes 8 to 10, in which
the recognition result of the motion includes position information of the object, and
the control means controls a substantial frame rate of a region including a region corresponding to the position information of the object or a region other than the region including the region corresponding to the position information of the object.

### Supplementary Note 12

The video processing apparatus according to any one of Supplementary Notes 8 to 11, further including motion vector detection means for detecting a motion vector indicating a magnitude of movement related to each region of the frame of the second video from the second video,
in which the control means controls the change in the display content for each region in the second video according to the detected motion vector.

### Supplementary Note 13

The video processing apparatus according to Supplementary Note 12, further including:
a first encoder configured to encode the second video in which the change in the display content is controlled; and
a second encoder including the motion vector detection means.

### Supplementary Note 14

The video processing apparatus according to Supplementary Note 13, in which
the second encoder calculates a difference between a prediction frame, in which a motion of a frame input next to a second frame is predicted by applying the motion vector, and the frame input next to the second frame, and
the control means controls the change in the display content for each region in the second video based on the motion vector and the difference.

### Supplementary Note 15

A video processing method including:
recognizing a motion of an object included in a first video captured by a sensor; and
controlling a change in a display content for each frame of a second video captured by the sensor for each region in the second video according to a recognition result of the motion.

The video processing method according to Supplementary Note 15, in which the change in the display content of the frame of the second video is controlled by copying, to a predetermined region of a first frame included in the second video, a content of the predetermined region of a frame before the first frame.

### Supplementary Note 17

The video processing method according to Supplementary Note 15 or 16, in which the recognition result of the motion includes a type of the motion of the object.

### Supplementary Note 18

The video processing method according to any one of Supplementary Notes 15 to 17, in which
the recognition result of the motion includes position information of the motion, and
the change in the display content of a region including a region corresponding to the position information of the object or a region other than the region including the region corresponding to the position information of the object is controlled.

### Supplementary Note 19

The video processing method according to any one of Supplementary Notes 15 to 18, in which
a motion vector indicating a magnitude of movement related to each region of the frame of the second video is detected from the second video,
the change in the display content for each region in the second video is controlled according to the detected motion vector.

### Supplementary Note 20

The video processing method according to Supplementary Note 19, in which
a difference between a prediction frame, in which a motion of a frame input next to a second frame is predicted by applying the motion vector, and the frame input next to the second frame is calculated, and
the change in the display content is controlled for each region in the second video based on the motion vector and the difference.

A video processing program for causing a computer to execute processing of:
recognizing a motion of an object included in a first video captured by a sensor; and
controlling a change in a display content for each frame of a second video captured by the sensor for each region in the second video according to a recognition result of the motion.

### REFERENCE SIGNS LIST

1 REMOTE MONITORING SYSTEM
10 VIDEO PROCESSING SYSTEM
11 MOTION RECOGNITION UNIT
12 CONTROL UNIT
20 to 22 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
110 VIDEO ACQUISITION UNIT
111 OBJECT DETECTION UNIT
120 RECOGNITION RESULT ACQUISITION UNIT
121 TRACKING INFORMATION ACQUISITION UNIT
122 FRAME RATE ACQUISITION UNIT
130 FRAME RATE DETERMINATION UNIT
131 MOTION VECTOR AND RESIDUAL ACQUISITION UNIT
132 VARIATION AMOUNT CALCULATION UNIT
133 FRAME SKIP DETERMINATION UNIT
140 FRAME RATE CONTROL UNIT
150, 150a, 150b ENCODER
151 DIVISION UNIT
153 RESIDUAL CALCULATION UNIT
154 ENCODING UNIT
160 TERMINAL COMMUNICATION UNIT
170 STORAGE UNIT
171 FRAME RATE SEARCH UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 MOTION RECOGNITION UNIT
231 OBJECT DETECTION UNIT
232 TRACKING UNIT
233 MOTION PREDICTOR
234 MOTION DETERMINATION UNIT
240 RECOGNITION RESULT NOTIFICATION UNIT
241 TRACKING INFORMATION NOTIFICATION UNIT
242 FRAME RATE NOTIFICATION UNIT
300 BASE STATION
400 MEC
401 COMPRESSION BIT RATE CONTROL FUNCTION

What is claimed is:

1. A video processing system comprising:
a memory configured to store instructions, and
a processor configured to execute the instructions to;
recognize a motion of an object included in a first video captured by a sensor; and
control a change in a display content for each frame of a second video captured by the sensor for each region in the second video according to a recognition result of the motion.

2. The video processing system according to claim 1, wherein the processor is further configured to execute the instructions to control the change in the display content of the frame of the second video by copying, to a predetermined region of a first frame included in the second video, a content of the predetermined region of a frame before the first frame.

3. The video processing system according to claim 1, wherein the recognition result of the motion includes a type of the motion of the object.

4. The video processing system according to claim 1, wherein
the recognition result of the motion includes position information of the object, and
the processor is further configured to execute the instructions to control the change in the display content of a region including a region corresponding to the position information of the object or a region other than the region including the region corresponding to the position information of the object.

5. The video processing system according to claim 1, wherein the processor is further configured to execute the instructions to detect a motion vector indicating a magnitude of movement related to each region of the frame of the second video from the second video, and
control the change in the display content for each region in the second video according to the detected motion vector.

6. The video processing system according to claim 5, further comprising:
a first encoder configured to encode the second video in which the change in the display content is controlled; and
a second encoder configured to detect the motion vector.

7. The video processing system according to claim 6, wherein
the second encoder calculates a difference between a prediction frame, in which a motion of a frame input next to a second frame is predicted by applying the motion vector, and the frame input next to the second frame, and
the processor is further configured to execute the instructions to control the change in the display content for each region in the second video based on the motion vector and the difference.

8. A video processing apparatus comprising:
a memory configured to store instructions, and
a processor configured to execute the instructions to;
recognize a motion of an object included in a first video captured by a sensor; and
control a change in a display content for each frame of a second video captured by the sensor for each region in the second video according to a recognition result of the motion.

9. The video processing apparatus according to claim 8, wherein the processor is further configured to execute the instructions to control the change in the display content of the frame of the second video by copying, to a predetermined region of a first frame included in the second video, a content of the predetermined region of a frame before the first frame.

10. The video processing apparatus according to claim 8, wherein the recognition result of the motion includes a type of the motion of the object.

11. The video processing apparatus according to claim 8, wherein
the recognition result of the motion includes position information of the object, and
the processor is further configured to execute the instructions to control the change in the display content of a region including a region corresponding to the position information of the object or a region other than the region including the region corresponding to the position information of the object.

12. The video processing apparatus according to claim 8, wherein the processor is further configured to execute the instructions to detect a motion vector indicating a magnitude of movement related to each region of the frame of the second video from the second video, and
control the change in the display content for each region in the second video according to the detected motion vector.

13. The video processing apparatus according to claim 12, further comprising:
a first encoder configured to encode the second video in which the change in the display content is controlled; and
a second encoder configured to detect the motion vector.

14. The video processing apparatus according to claim 13, wherein
the second encoder calculates a difference between a prediction frame, in which a motion of a frame input next to a second frame is predicted by applying the motion vector, and the frame input next to the second frame, and
the processor is further configured to execute the instructions to control the change in the display content for each region in the second video based on the motion vector and the difference.

15. A video processing method comprising:
recognizing a motion of an object included in a first video captured by a sensor; and
controlling a change in a display content for each frame of a second video captured by the sensor for each region in the second video according to a recognition result of the motion.

16. The video processing method according to claim 15, wherein the change in the display content of the frame of the second video is controlled by copying, to a predetermined region of a first frame included in the second video, a content of the predetermined region of a frame before the first frame.

17. The video processing method according to claim 15, wherein the recognition result of the motion includes a type of the motion of the object.

18. The video processing method according to claim 15 wherein
the recognition result of the motion includes position information of the object, and
the change in the display content of a region including a region corresponding to the position information of the object or a region other than the region including the region corresponding to the position information of the object is controlled.

19. The video processing method according to claim 15, wherein
a motion vector indicating a magnitude of movement related to each region of the frame of the second video is detected from the second video,
the change in the display content for each region in the second video is controlled according to the detected motion vector.

20. The video processing method according to claim 19, wherein
a difference between a prediction frame, in which a motion of a frame input next to a second frame is predicted by applying the motion vector, and the frame input next to the second frame is calculated, and
the change in the display content is controlled for each region in the second video based on the motion vector and the difference.
